(19) United States
(12) Patent Application Publication
(10) Pub. No.: US 2005/0109834 A1
(43) Pub. Date: May 26, 2005

(54) System and method for providing financial data

(76) Inventors: Douglas A. Grindel, Oscedla, IN (US); Nelson C. Coble, Elkhart, IN (US)

Correspondence Address: BARNES & THORNBURG, 11 SOUTH MERIDIAN, INDIANAPOLIS, IN, 46204, US

(21) Appl. No.: 10/993,372

(22) Filed: Nov. 19, 2004

Related U.S. Application Data
(60) Provisional application No. 60/523,608, filed on Nov. 20, 2003.

(51) Int. Cl. G06F 17/60; G06K 19/00

(52) U.S. Cl. 235/379; 705/35

(57) ABSTRACT

A system and method for providing financial data to a user includes retrieving financial data from a database, determining if a predefined trigger event has occurred based on the retrieved financial data, and displaying the financial data to the user. Portions of the displayed financial data may be identified, such as highlighted, to the user based on the occurrence of the triggering event. The method may also include providing financial recommendations to the user based on the financial data and/or the occurrence of the trigger event.

This patent application claims priority to and the benefit of U.S. Provisional Patent Application No. 60/523,608, filed on Nov. 20, 2003.

### BACKGROUND OF THE INVENTION

The present disclosure relates generally to systems and methods for providing financial data to a user, and more particularly to a systems and methods for providing financial data to a user over a network.

Financial data includes all such data related to the finance industry. For example, and without limitation, financial data may include such data as loan rates, fees, treasury rates, deposit rates, bond rates, and the like. Additionally, financial data may include financial data related to a particular institution of the finance industry. For example, financial data may include such financial institution related data as current and past loan interest rates, current and past deposit interest rates, fee amounts, item maturity information, customer deposit and withdraw rates, finding information, information concerning promotions offered by the institution, special requirements of the institution, and the like. In addition, financial data may include the financial data of competitors of the particular institution, as determined by market, geographical location, or other factors. Further, financial data may include additional market data or other data that affects the finance industry. For example, financial data may also include market data that has a potential to cause a change in loan rates or the like.

Financial institutions, such as banks and other lending facilities, use financial data in the process of making financial decisions. For example, a financial institution may use financial data in determining a particular interest rate or loan period. Financial data is typically provided to a financial institution by third parties in the form of printed reports. Due to the volume of financial data generated over a relatively short period of time and the inherent complexity in analyzing such a volume of data, the typical financial data report includes only current financial data.

### SUMMARY OF THE INVENTION

The present invention comprises one or more of the features recited in the appended claims and/or the following features which, alone or in any combination, may comprise patentable subject matter:

A method for providing financial data to a user is provided. The method may include defining a trigger event. The trigger event may be defined as a date such as a date of maturity of a loan or deposit, an interest rate such as deposit interest rate or loan interest rate, or other finance related criteria.

The method may also include retrieving financial data from a database. The financial data may be retrieved based on the identity of the user, the access level granted to the user, or the like. The financial data may include such financial data as loan rates, deposit rates, dates of maturity, or any other type of financial data useful in making financial decisions. The financial data may include financial data from a financial institution, such as a bank or loan company, associated with the user (e.g., the user may be an employee of the financial institution). Additionally, the financial data may include financial data of a competitor of the financial institution such as a competing bank or loan company.

The method may further include determining an occurrence of the trigger event based on a portion of the retrieved financial data. Determining an occurrence of the trigger event may include determining if an interest rate of the portion of the financial data is greater than, equal to, and/or less than a predetermined interest rate such as a competitor's rate or a standard rate. Alternatively, determining an occurrence of the trigger event may include determining if a maturity date of the portion of the financial data is within a predetermined time period such a week, a month, six months, or the like.

The method may also include displaying the financial data to the user. The data or portions thereof may be identified to the user based on the occurrence of any trigger event. For example, if an interest rate of the retrieved financial data is greater than a predetermined interest rate, the interest rate may be displayed to the user and highlighted with a color to identify to the user that the interest rate triggered the trigger event. Additionally, portions of financial data that has changed or that has changed by a predetermined amount may be identified, such as highlighted, to the user to notify the user of the change in financial data.

A system for providing financial data to a user is also provided. The financial data may be provided to the user over a network. The system may include a database. The database may have stored therein financial data, such as financial data of a financial institution associated with the user. The database may also include financial data of competitors of the financial institution. The system may also include a server electrically coupled to the database. The server may be configured to retrieve financial data from the database based on a request from the user. The server may also be configured to determine an occurrence of the trigger event based on a portion of the financial data. The server may further be configured to transmit the financial data to the user. The server may also be configured to identify the portion of the financial data to the user based on the occurrence of the trigger event.

The above and other features of the present disclosure, which alone or in any combination may comprise patentable subject matter, will become apparent from the following description and the attached drawings.

### BRIEF DESCRIPTION OF THE DRAWINGS

The detailed description particularly refers to the following figures, in which:

FIG. 1 is a simplified block diagram of a network-based system for providing financial data to a user;

FIG. 2 is a process flow diagram of the construction and maintenance of a financial database for use with the system of FIG. 1;

FIG. 3 is a process flow diagram of an algorithm for providing financial data to a user for use with the system of FIG. 1;

FIG. 4 is a process flow diagram illustrating a recommendation step of the algorithm of FIG. 3; and

FIGS. 5-12 illustrate various screen displays which are displayed to the user of the system of FIG. 1.

### DETAILED DESCRIPTION OF THE DRAWINGS

While the concepts of the present disclosure are susceptible to various modifications and alternative forms, specific exemplary embodiments thereof have been shown by way of example in the drawings and will herein be described in detail. It should be understood, however, that there is no intent to limit the concepts of the present disclosure to the particular forms disclosed, but on the contrary, the intention is to cover all modifications, equivalents, and alternatives falling within the spirit and scope of the disclosure.

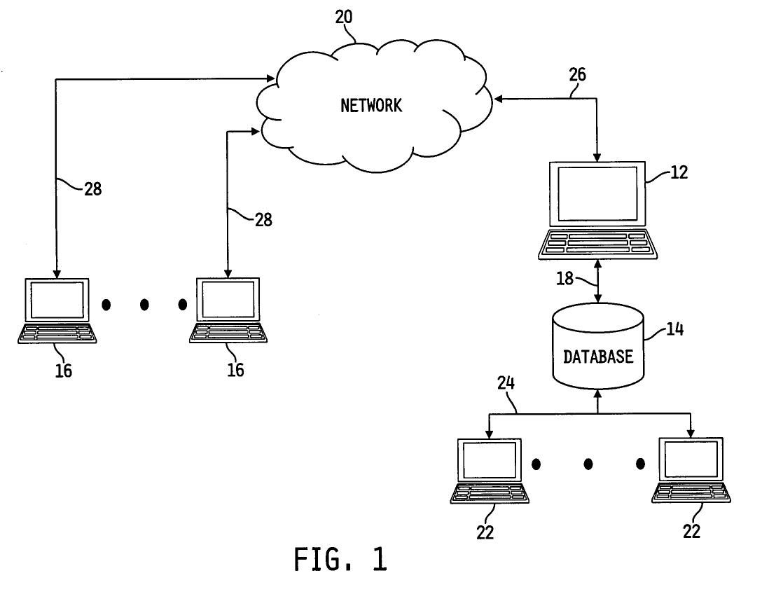

Referring now to FIG. 1, in regard to one illustrative embodiment, a system 10 for providing financial data to a user has a network server machine 12 which communicates with a database 14 and a number of client machines 16. The server 12 communicates with the database 14 via a number of communication links 18 and communicates with the client machines 16 via a network 20. Additionally, in some embodiments, the system 10 may include a number of data entry machines 22 which communicate with the database 14 via a number of communication links 24. As illustrated in FIG. 1, the system 10 may include any number of clients 16 and data entry machines 22. Additionally, although only one server 12 and one database 14 are shown in FIG. 1, it should be appreciated that the system 10 may include any number of network servers 12 and databases 14.

In a conventional manner, each of the network servers 12, the clients 16, and the data entry machines 22 includes a number of components commonly associated with such machines. For example, although not shown in detail in the drawings, each of the server(s) 12, the clients 16, and the data entry machines 22 may include, amongst other things customarily included in such machines, a central processing unit (“CPU”), a non-volatile memory such as a read only memory (“ROM”), a volatile memory such as a random access memory (“RAM”), and one or more data storage devices. It should also be appreciated that such components may be integrated into a single housing or may be provided as a number of separate, discrete devices. It should also be realized that the network server 12, the clients 16, and the data entry machines 22 may be operated with known, commercially available software operating systems.

As such, the network server 12 may be embodied as any type of commercially available network server. The storage devices associated with the network server 12 maintain a number of databases and files which are utilized in the construction and operation of an information portal such as a website. The network server 12 also functions as a gateway for exchanging information across networks that are incompatible and that use different protocols. The gateway may be embodied as any combination of commercially available hardware and/or software that connects different types of networks such that information can be exchanged therebetween.

The database 14 may be embodied as any type of database including stored data in the form of a single or multiple files. In some embodiments, the database 14 may be stored in the server 12 or may be stored in a separate storage device such as a hard drive or the like. The database 14 may also be embodied as a data server having a data server machine communicating with a database file or files stored therein or in a separate storage device. Accordingly, it should be appreciated that the database 14 may be embodied as data stored in any one of a number of storage devices. Additionally, the database 14 may be one of or a combination of any type of databases including, for example, relational databases and flat-file databases. Further, the database 14 may have associated with it a database management system to facilitate the management of data stored in the database 14. Such a database management system may include, for example, Oracle Database which is commercially available from Oracle Corporation of Redwood Shores, Calif.

The clients 16 preferably include an output device such as a display monitor for displaying a number of images to a user. As such, the clients 16 may be embodied as any type of commercially available computing device such as a personal computer (“PC”). Moreover, the clients 16 may also be embodied as “mobile” devices such as a cellular phones, mobile data terminals, portable computers, personal digital assistants (“PDA”), or other devices of similar kind.

As shown in FIG. 1, the network server 12 is coupled to the network 20 via a communications link 26, whereas the number of clients 16 are coupled to the network 20 via a number of communications link 28. It should be appreciated that the communications links 18, 24, 26, 28 may be provided as any number of different types of data links including both wired and wireless data links. Moreover, it should also be appreciated that one or more intervening modems (not shown), data routers (not shown), and/or internet service providers (“ISPs”) (not shown) may be used to transfer the data between the network server 12, the clients 16, and the network 20.

The network 20 of the present disclosure may be embodied as any type of network such as a LAN or WAN. Moreover, in a specific illustrative embodiment, the network 20 is embodied as a publicly-accessible global network such as the Internet.

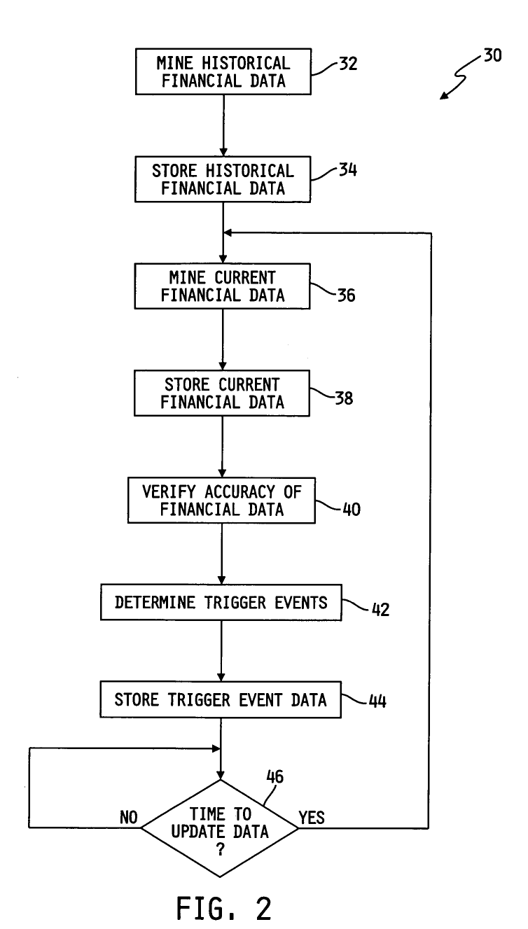

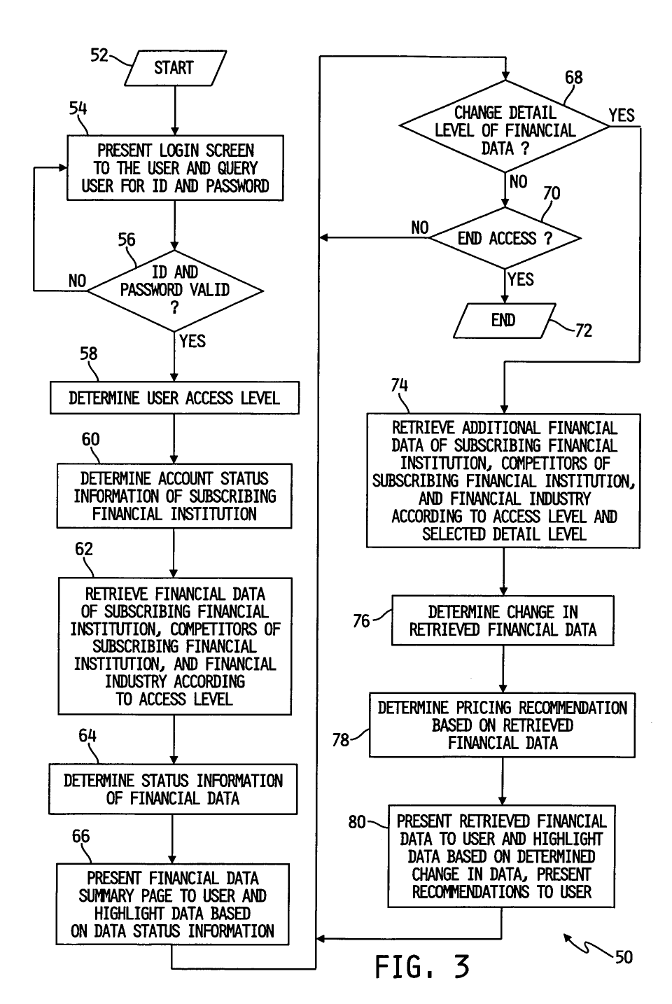

Referring now to FIG. 2, the database 16 is constructed by researching, collecting, and otherwise mining financial data related to a subscribing financial institution of the system 10, a number of competitors of the subscribing financial institution, and various other financial industry data. The subscribing financial institution may be any institution, company, or other entity that uses system 10 to obtain financial data. For example, the subscribing financial institution may be a bank or other loan company. The financial data may be obtained from a number of sources including publicly and commercially available industry reports, user supplied reports, and the like. In addition to being constructed, the database 16 is maintained and supplemented with new financial data as it becomes available. Accordingly, a process 30 for constructing and maintaining a financial database is illustrated in FIG. 2.

The process 30 begins with process step 32 in which historical financial data is mined or otherwise collected. The data mined in process 30 includes any data which is not current as of the time of collection including financial data which is hours old to days old, to years old, or older. Additionally, the financial data mined in process step 32 includes financial data of the subscribing financial institution related to the user of the system 10, of competitors of the subscribing financial institution, and of the general financial industry including, but not limited to, governmental agencies. The historical financial data may be collected from a number of sources including, for example, previously published public and commercial industry reports, historical reports or other relevant data provided by the subscribing financial institution, and other previously published sources. Once the historical financial data is mined, the data is stored in the database 14 in process step 34.

In process step 36, current financial data is collected. Similar to process step 32, the current financial data collected in process step 36 includes financial data of the subscribing financial institution related to the user of the system 10, of competitors of the subscribing financial institution, and of the general financial industry including, but not limited to, governmental agencies. The current financial data may be collected using those sources listed above in regard to step 32. In addition, in order to collect the most current and correct financial data available, the current financial data may be collected via contacting, such as via a telephone call, the subscribing financial institution related to the user of the system 10 and the competitors of the subscribing financial institution. The collected current financial data is subsequently stored in the database 14 in process step 38.

To ensure that the collected financial data is valid, the financial data collected and stored in the database 14 is verified in process step 40. The financial data may be verified using one of a number of verification methods including random calling of the subscribing financial institution and competitors of the subscribing financial institution to verify the data values, double checking sources of the financial data for collection errors, and reviewing changes in the collected financial data relative to previously collected financial data. For example, if such a change in the collected financial data relative to previously collected financial data is outside a predetermined threshold, the collected financial data could be reexamined for accuracy.

In addition to verifying the accuracy of the financial data collected and stored in the database 14, certain predetermined trigger events are identified in process step 42. Trigger events include any event related to or based on the financial data which may be of interest to the subscribing financial institution or individual users of the system 10. Such trigger events may include, for example, the date of maturity of a deposit, the level of interest rates charged, dates of bonuses or the like given to employees of a particular corporation of interest, or the like. The trigger events determined in process step 42 are stored in the database 14 in process step 44. The trigger events may be linked in the database 14 to the particular financial data upon which they were determined.

Process 30 determines if the database 14 is to be updated based on the current time in process step 46. The time of update may be based on the date, time of day, or other temporally related data. For example, the database 14 may be scheduled to be updated on a daily basis, a weekly basis, or the like. If the database 14 is not due to be updated, the process 30 continues to monitor for the update time. However, if the database is due to be updated the process 30 loops back to process step 36. The process steps 36-46 are subsequently repeated and new current financial data is mined and verified.

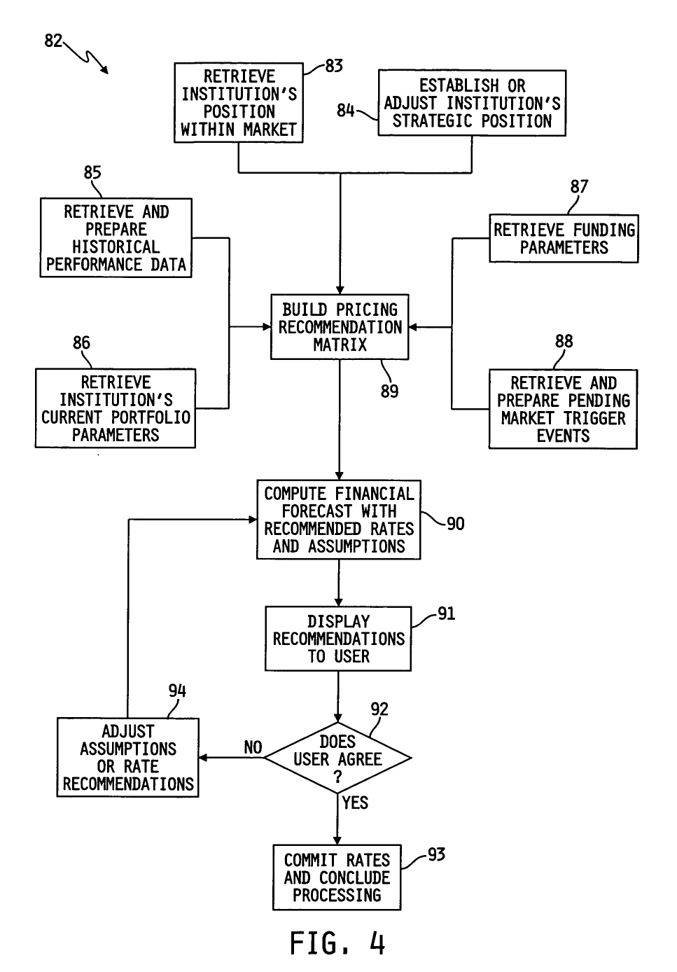

Referring now to FIG. 3, in operation, a user of one of the clients 16 requests financial data from the server 12. In response, the server 12 retrieves the financial data from the database 16 based on, in part, the identity of the user and the subscribing financial institution related to the user and transmits the financial data to the user via the network 20. Accordingly, a method or process 50 for providing financial data to a user begins with process step 52 in which a user of one of the clients 16 contacts the server 12 via the network 20. For example, the user may navigate to a website or similar portal supplied by the server 12 via a hyptertext markup language (HTML) link. Once the user has accessed the server 12, for example via the website, the server 12 transmits a login screen to the client 16 via the network 20 for presentation to the user. An illustrative login screen 100 is illustrated in FIG. 4. The login screen includes a login area 102 having a user ID entry cell 104 and a user password cell 106. The user may enter his ID and password in the cell 104, 106, respectively, and proceed by clicking a login button 107. Once the user has entered his ID and password, the server 12 determines if the user ID and associated password are valid in process step 56. A list of user IDs and associated passwords may be stored, for example in database 14, to facilitate the validation of users. To validate the user ID and password, the server 12 may determine if the supplied ID and password match an entry in the list of user IDs and passwords. In addition, other validation techniques may be used including internet protocol (IP) address verification, media access code (MAC) address verification, and the like. If the user supplied ID and/or password are not valid, the process 50 loops back to process step 54 and provides the user with another attempt to supply the correct user ID and password. Alternatively, the process 50 may end after a predetermined number of invalid entry attempts.

If the user ID and password are determined to be valid in process step 56, the user's access level is determined in process step 58. The user access level may be determined by the server 12 by comparing the user ID to a table of access level values stored in, for example, the database 14 or other determination method. Once the user's access level has been determined, account status information of the subscribing financial institution related to the user is determined in process step 60. Account status information may include any information related to the subscribing financial institution, the individual user's access account, or the like. For example, account status information may include the dates and times of the last update of the subscribing financial institution financial data such as the time and date of the last update of deposit and loan rates and the like. In addition, account status information may include due dates of maintenance fees required for access to the system 10.

In process step 62, financial data of the subscribing financial institution related to the user and competitors of the subscribing financial institution is retrieved from the database 14. The financial data may also include various financial industry data. The retrieved financial data includes summary financial data capable of providing a general financial overview to the user. The financial data retrieved in process step 62 is based, in part, on the access level of the user as determined in process step 58. In this way, portions or subsets of financial data of the subscribing financial institution, competitors of the subscribing financial institution, or other retrieved data may be viewable by a selected group of personnel and restricted from other personnel. For example, if the user is a loan officer of a bank, the retrieved financial data may include financial data of the bank and it's competitors that is of interest to loan officers. Alternatively, if the user is an executive of the bank, the retrieved financial data may include financial data of the bank and it's competitors that is of interest to bank executives.

The status information of the retrieved financial data is subsequently determined in process step 64. The status information includes such information as trigger events, the change in financial data relative to previous data, and trends in the status information. Such status information may be determined using one of a number of methodologies including comparing the retrieved financial data, or portions thereof, with industry standards, previous financial data, and competitor's financial data.

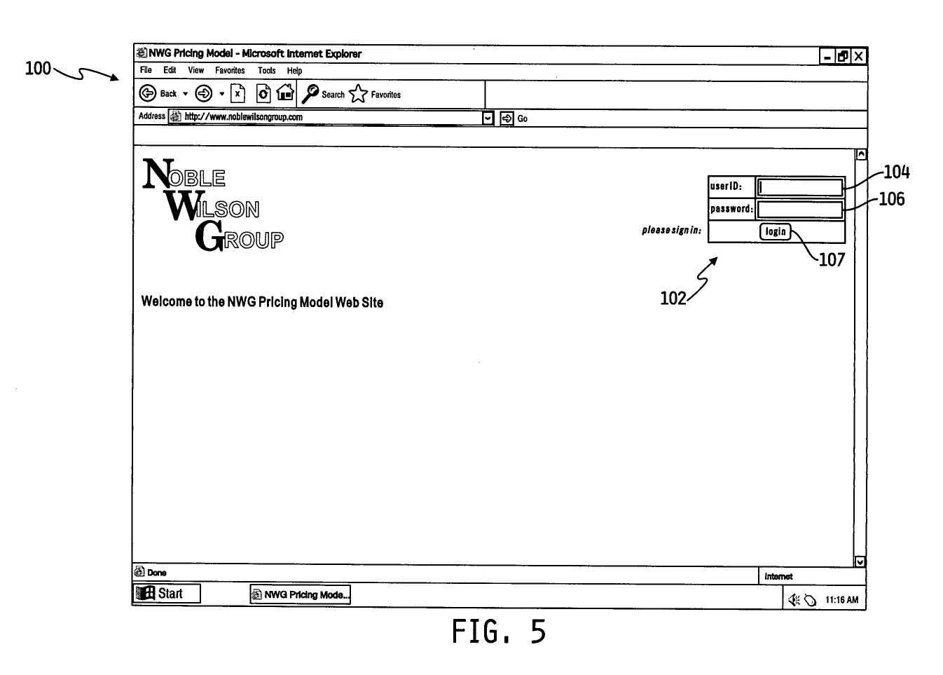

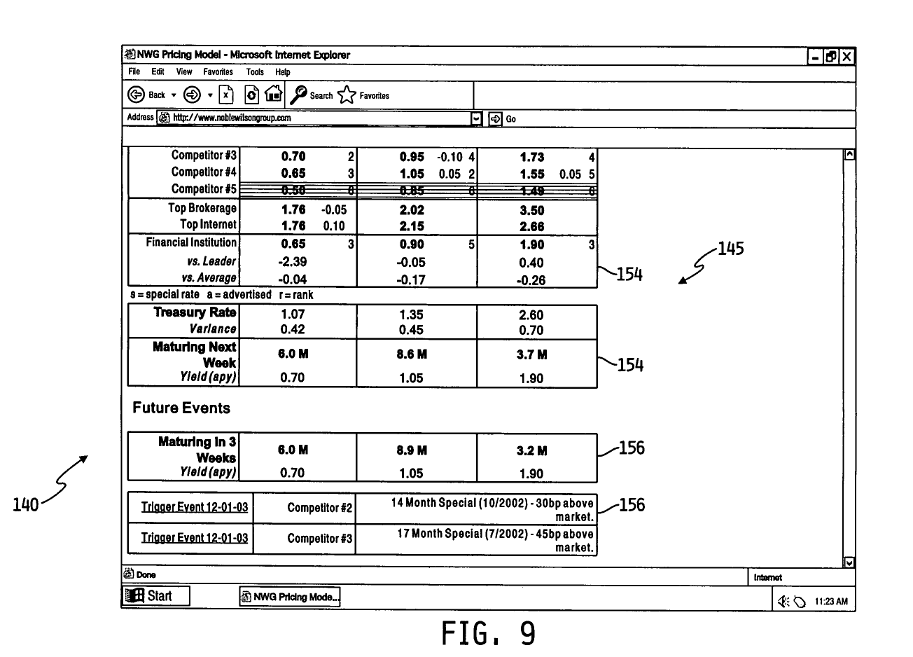

In process step 66, the server 12 transmits the retrieved financial data to the client 16 via the network 26. The financial data is presented to the user via the client 16 and portions of the financial data are highlighted according to the data status information determined in process step 64. An illustrative financial data summary screen 110 is shown in FIG. 5. The summary screen 110 includes a selection bar 112 having a number of selection buttons. Illustratively, the selection bar 112 includes a product navigation button 114, a reports button 116, a trigger events button 118, a user settings button 120, and a logout button 122. The user may access additional functionality of the system 10 via selection of one of the buttons 114, 116, 118, 120, and 122 as discussed below in regard to FIGS. 9-12. The summary screen 110 also includes a status message area 124 within which is displayed any account status information retrieved in the process step 60.

Additionally, the summary screen 110 includes a data area 126 within which is displayed the financial data retrieved in step 62. Illustratively, the data area 126 includes a data table 128 having columns defined by types of financial data such as deposits and loans and rows defined by geographical areas. Financial data, such as deposit and loan rates, maturity dates, and other financial rates or dates, may be displayed in the individual cells of the table 128. The individual cells of the table 128, and any financial data that may be located in the cells, are highlighted or otherwise identified according to the status of the financial data as determined in process step 64. In this way, the highlighting of the data cells provides an overview indication of the status of the associated financial data and such indication may be quickly determined by the user.

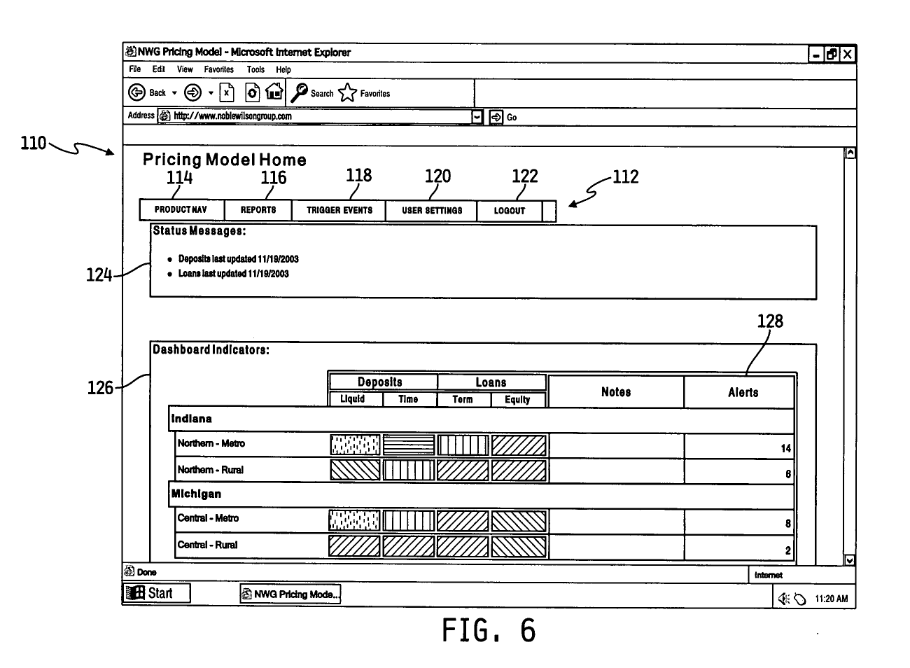

The data table 128 also includes a notes column 130 and an alerts column 132. Any notes applicable to the geographical area may be viewed in the notes column 130. The alerts column 132 displays the number of alerts for the associated geographical area as defined by any predefined trigger events. In addition, as illustrated in FIG. 6, a legend 134 may be included in data area 126 or be otherwise accessible. The legend 134 informs the user of the definitions or meanings of the various types of highlights or other indicators used in the data table 128. In the illustrative embodiment, each financial data cell of the data table 128 is highlighted with one of five different colors or shading based the status of the status of the financial information associated with each cell. Accordingly, the legend 134 includes a brief description of the definition of each highlight color.

In process step 68, the process 50 determines if the user requires additional detail information related to the summary information presented in process step 66. A user may request a change in the level of detail of the financial data by selecting a particular area of the data area 126. For example, the user may select or “click” on a particular financial data cell of the data table 128, one of the financial data type headers such as “Deposits”, or one of the geographical headers such as “Indiana”. If a user does not request a change in the detail level of the financial information, the process 50 determines if the user desires to end his access to the financial data. If so, the process 50 terminates in process step 72. If the user does not wish to end his access, the process 50 loops back to process 68 to determine if the user requires a change in the detail level of the financial data.

However, if a user requests a change in the detail level of the presented financial data, for example by selecting or “clicking” an appropriate area of the summary page or subsequent data page, additional financial data is retrieved from the database 14 by the server 12 based, in part, on the access level of the user and the selected detail level of financial data. The retrieved financial data may include financial data of the subscribing financial institution associated with the user, competitors of the subscribing financial institution, as well as general industry financial data. The retrieval and presentation process of the financial data in process step 74 is similar to the retrieval and presentation process of step 66.

Changes in the retrieved financial data are determined in process step 76. Such changes may be determined, for example, by comparing the retrieved financial data to previous financial data. In process step 78, recommendations based on the retrieved financial data are determined. The recommendations may be based on such factors as the change in financial data relative to previous data, values of the financial data related to the user's competitor, the relation of the retrieved financial data to an industry standard, and the like. Such recommendations may include, but are not limited to, recommendations of interest rate values, terms of loans, time length of deposits and loans, investing suggestions, and similar financial recommendations.

An illustrative recommendation algorithm 82 is illustrated in FIG. 4. The algorithm 82 includes a process step 83 in which the subscribing institution's position within the market is determined. The subscribing institution's position may be determined based on its market share of the particular financial market of interest. For example, if a recommendation for interest rates of loans are to be determined, the subscribing institution's loan market share is determined in process step 83. In some embodiments, a market position ranking number may be assigned to the subscribing institution based on its determined market share.

The subscribing institution's strategic position is determined in process step 84. The strategic position of the institution may be determined based on the desired “aggressiveness” of the recommendation. In some embodiments, a strategic position value is assigned in process step 84 based on the desired “aggressiveness” of the recommendation. For example, if the subscribing institution desires to acquire addition market share in the particular financial market of interest, the value determined in process step 84 may be high. However, if the subscribing institution desires to maintain or defend its current market share, the value determined in process step 84 may be low.

Historical and current financial data of the subscribing institution and/or competitors of the subscribing institution is retrieved in process steps 85 and 86, respectively. The historical financial data retrieved in process step 85 may include such data as interest rates, business volume, market share, results of past market positions, trends over time, and the like. The current financial data retrieved in process step 86 may include such data as the number and identity of deposits and loans maturing within a relatively short time period (e.g., within the following week), current rates, market environment factors, and other data having a potential to affect the financial recommendation.

In process step 87, the funding rate of the particular financial market of interest is determined. The finding rate may be an averaged or otherwise predetermined value based on a number of financial market indicators such as the stock market, treasury market, and other federal and open market factors. Alternatively, the funding rate may be determined based on other variables. Typically, the funding rate is adjusted over set time intervals such as daily, weekly, or the like. In some embodiments, the funding rate determined in process step 87 represents a minimum or near-minimum rate, such as an interest rate, to be recommended.

Trigger events are retrieved and/or determined in process step 88. Similar to the trigger events determined in process step 42 of algorithm 30 described above in regard to FIG. 2, the trigger events determined in process step 88 include any event related to or based on the financial data which may be of interest to the subscribing financial institution. Such trigger events may include, for example, the date of maturity of a deposit, the level of interest rates charged, dates of bonuses or the like given to employees of a particular corporation of interest, or the like.

In process step 89, a pricing recommendation matrix is determined. The pricing recommendation matrix includes a number of rate values and projected volumes, in monetary units or other unit measurement, for each rate value. The rate values of the pricing recommendation matrix is determined based on the historical financial data determined in process step 85 and the current financial data determined in 86 and may be determined based on a regression algorithm. The rate values so determined may also be adjusted or otherwise changed based on the results or values determined in process steps 83, 84, 87, and 88. Accordingly, the pricing recommendation matrix includes Recommended rates and projected market volumes are determined in process step 90 based on the pricing recommendation matrix determined process step 89. Based on the recommended rate and projected market volumes, a projected or assumed market revenue may also be determined in process step 89. In addition, in process step 89, the recommended rate may be further adjusted based on any one or more of the process steps 83, 84, 87, 88. For example, if the recommended rate is below the finding rate determined in process step 87, the recommended rate may be adjusted to equal or exceed the finding rate. The recommended rate is subsequently displayed to the user of system 10 in process step 91. In addition, the projected market volumes and/or projected market revenue may also be displayed to the user. The recommended rate may be displayed via a screen, table, or as part of an existing screen display.

In process step 92, the user is queried to determine if the recommended rate is acceptable. The user may determine if the rate is acceptable based on, for example, the projected market volumes and/or projected market revenue as well as the finding rate determined in step 87. If the recommended rate is acceptable, the process flow of the algorithm 82 advances to process step 93 in which the rates are committed and any rate dependent financial data may be adjusted. However, if the rate is not acceptable, an the rate recommendations and associated assumptions are adjusted in process step 94. The algorithm 82 then loops back to process step 90 in which new financial results such as projected market revenue based on the new recommended rate and assumptions is determined. The algorithm 82 continues to loop in this manner until a recommended rate is acceptable to the user.

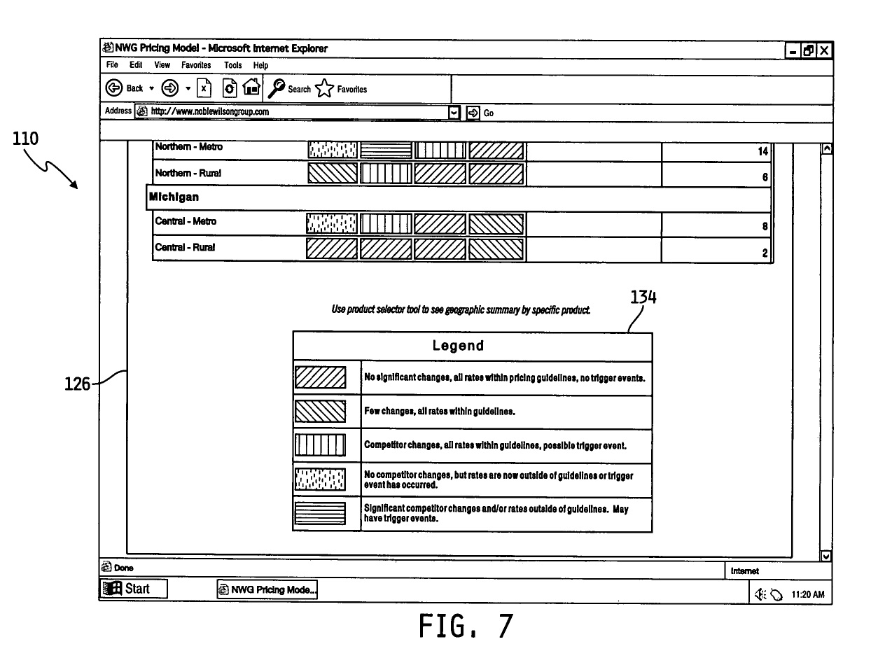

Referring now back to FIG. 3, in process step 80 of algorithm 50, the server 12 transmits the retrieved financial data to the client 16 via the network 26. The financial data is presented to the user via the client 16 and portions of the financial data are highlighted according to the change in the financial data as determined in process step 76. An illustrative financial data detail screen 140 is shown in FIG. 7. The detail screen 140 includes a navigation area 142 and a data area 144 having displayed therein the retrieved financial data. The navigation area 142 includes a pricing region entry cell 146, a pricing district entry cell 148 and a report date entry cell 150. The user may change the region of the financial data presented in the data area 144 by use of the pricing region entry cell 146. For example, the user may select a different region from a number of regions presented in a “pull-down window” of the pricing region entry cell 146. The pricing regions may be divided by state, city, county, or any other geographical division. The user may also change the pricing district via the pricing district entry cell 148. A pricing district includes any sub-division of the pricing region. For example, a user may select between “metro” and “rural” pricing districts via the pricing district entry cell 148. The user may also change the report date via the report date entry cell 150 to review financial detail information from previous dates.

The data area 144 includes a number of data tables 145, each having columns broadly defined by the financial data type (i.e. short term, moderate term, long term, etc.) and rows defined by categories of financial data. In some embodiments, the columns of the data table 126 may be further divided into sub-columns of finer detail. For example, the “short term” column may be divided into a “6 month or less” sub-column and a “7 to 11 month” column. The detailed financial data displayed in the data area 144 may include such data as retention rates, new booking rates, change in revenue, and the like. Additionally, the financial data is highlighted or otherwise identified according to the change in the financial data as determined in process step 76. In one embodiment, the cells and financial data contained therein are highlighted or otherwise identified according to the legend 134 illustrated in FIG. 6. Alternatively, the cells may be highlighted using a simplified color scheme or other identification methodology. Illustratively, the cells of the data table 124 are highlighted according the change in financial data and the desirability of such change. For example, a negative or adverse change in financial data is highlighted with a red tone of color and a positive change in the financial data is highlighted with a green tone of color.

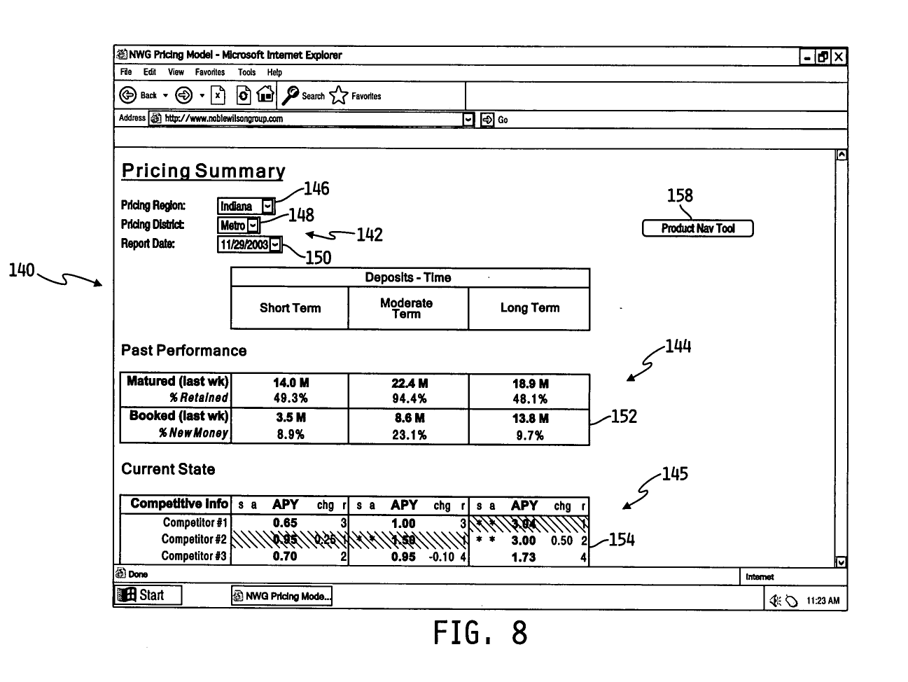

Illustratively, the data area 144 includes a past performance data table 152, a current state data table 154, and a future events data table 156. The data table 152 includes historical financial data, such as week old data, of the subscribing financial institution associated with the user. Illustratively, the data table 152 may include such historical financial data as the dollar amount of matured deposits, the dollar amount of booked deposits, and the associated percentages of the deposits. The data current state date table 154 may include current financial data of the subscribing financial institution as well as current financial data of a number of competitors of the subscribing financial institution. As illustrated in FIGS. 7 and 8, such current financial data may include the annual percentage yield (APY) offered by the subscribing institution and the competitors for each financial data type (i.e., short term, moderate term, and long term), the change in the APY, indications whether the offered APY is a special rate or advertised rate, and the ranking of the offered APY. As discussed above, any changes in the APY may be highlighted to indicate the change. In addition, the current state data table 152 may include a treasury rates and near-future financial data, as illustrated in FIG. 8. The future events data table provides the user with future financial data for the subscribing institution. For example, the illustrative data table 156 includes the amount of maturing deposits over the next three weeks. Further, the data table 156 may also provide the user with trigger event detail such as the trigger event definition and the competitor which triggered the event, as illustrated in FIG. 8.

The financial data detail screen 140 may also include a product navigation button 158. The product navigation button 158 may be used by the user to change the type of financial data displayed in the data display area 144. For example, the user may choose to display “deposits-time”, “deposits-liquid”, “loans-time”, or “loans-lines” via the product navigation button 158. In addition, other types of financial data may be selectable in other embodiments.

The recommendations determined in process step 78 are also displayed on the detail screen 120. Such recommendations may be identified or otherwise highlighted to draw the attention of the user. Alternatively, the recommendations determined in process step 76 may be provided via a secondary screen which is accessible from the detail screen 120.

After the retrieved financial data is presented to the user in process step 80, the process 50 advances to process step 68 in which the user may select or change the detail level of the currently displayed financial data. Accordingly, the user may continue to alter or change the detail level of the financial data.

Referring now back to FIG. 5, the user may also select one of the buttons 114, 116, 118, 120, or 122 to access additional functionality of the system 10. For example, the user may change the settings of the system 10 associated with the user by selecting the user settings button 120 or exit the system 10 by selecting the logout button 122. The user may also select the product navigation button 114 to change the type of financial data displayed as discussed above in regard to FIG. 7. In addition, the user may select the reports button 116 to produce a report of financial data. If the user selects the button 116, a report menu screen 160 is displayed to the user. As illustrated in FIG. 9, the report menu screen 160 includes a report type selection cell 160, a pricing region selection cell 162, a pricing district selection cell 164, and a report date selection cell 166. The user may enter report criteria via the cells 160, 162, 164, 166 and generate a financial report based on the report criteria via selection of a get report button 168. Once the report is generated, it may be saved and/or printed. The generated reports may be organized in a similar manner as the detailed financial data of FIGS. 7 and 8.

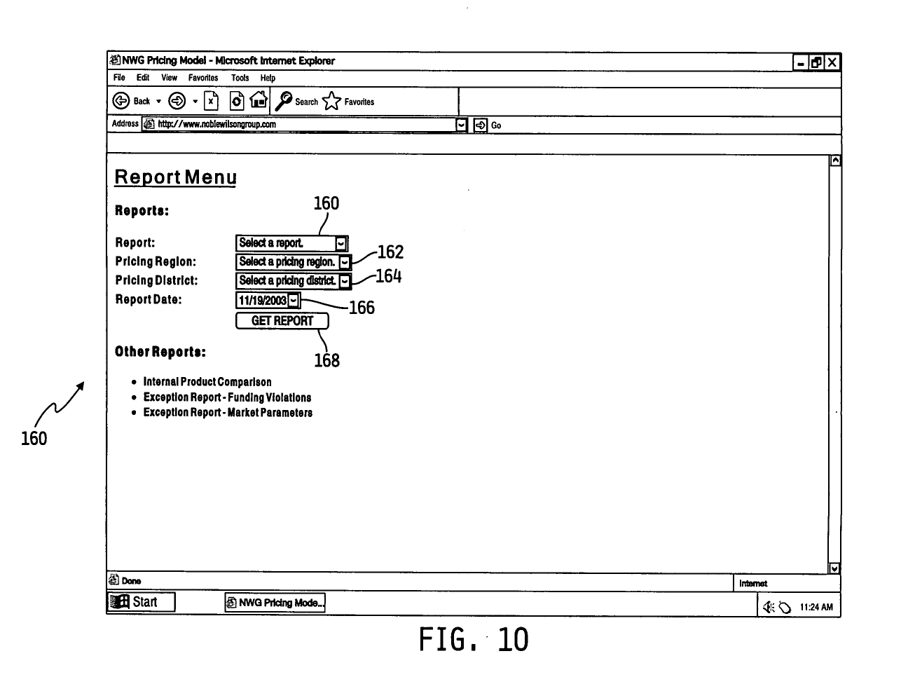

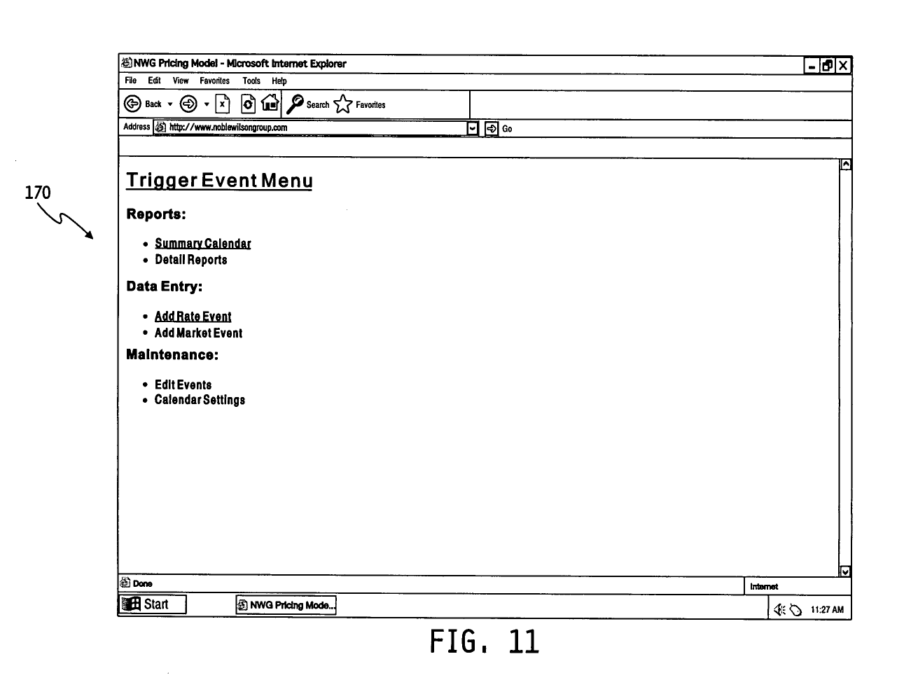

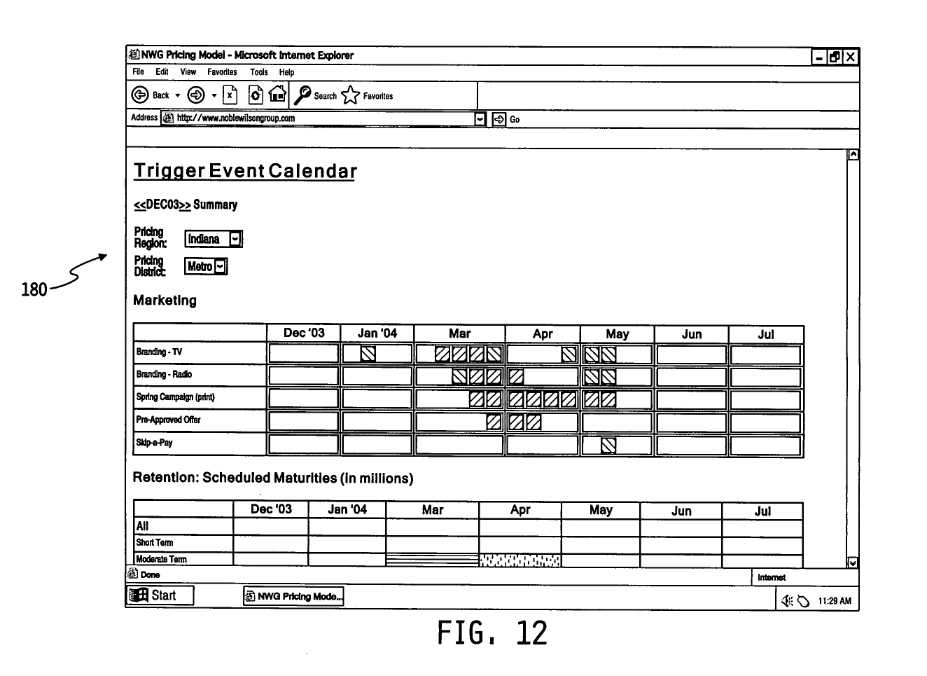

The user may also access a trigger event menu screen 170 via selection of the trigger events button 118. As illustrated in FIG. 10, the trigger event menu screen 170 allows the user to review a summary calendar of trigger event or a detailed report of trigger events. An exemplary summary calendar 180 is illustrated in FIG. 11. The summary calendar 180 provides an overview of triggering events occurring in different months according to different categories of financial data. For example, highlights are displayed under each month in which a trigger event has occurred.

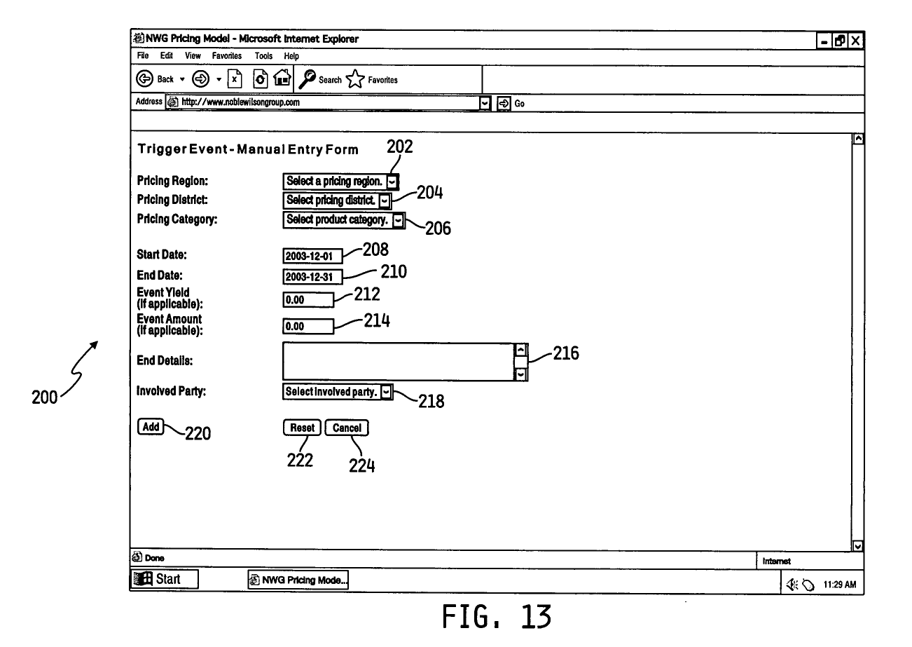

In addition, the user may enter new trigger events such as rate trigger events and market trigger events. An exemplary rate trigger event entry screen 200 is illustrated in FIG. 12. The user may enter the pricing region, pricing district, and product category for the trigger event via a pricing region entry cell 202, a pricing district entry cell 204, and a product category entry cell 206, respectively. In addition, the user may enter a start date for the trigger event via a start date entry cell 208 and an ending date for the trigger event via an ending date entry cell 210. The screen 200 also includes an event yield entry cell 212 and an event amount entry cell 214. If the triggering event is an amount of yield, the user may enter the event via the event yield entry cell 212. Alternatively, if the triggering event is a predetermined amount of change, the user may enter the event via the amount event amount entry cell 214. The user may also supply any event detail notes associated with the trigger events in a note filed 216. The user may select which party the trigger event is to be applied to via an involved party entry cell 218. For example, the trigger event may be applied to the subscribing institution or one or more competitors of the subscribing institution. Once the user has entered the appropriate trigger event data, the user may add the trigger event by selecting an add trigger event button 220. Alternatively, the user may cancel the trigger event by selecting a cancel button 224 or reset all the data cells of the trigger event entry screen 200 by selecting a reset button 222.

Referring back to FIG. 5, the user may also change the settings of the system 10 associated with the user by selecting the user settings button 120. The user may also exit the system 10 selecting the logout button 122.

While the disclosure has been illustrated and described in detail in the drawings and foregoing description, such an illustration and description is to be considered as exemplary and not restrictive in character, it being understood that only illustrative embodiments have been shown and described and that all changes and modifications that come within the spirit of the disclosure are desired to be protected.

There are a plurality of advantages of the present disclosure arising from the various features of the system and method described herein. It will be noted that alternative embodiments of the system and/or method of the present disclosure may not include all of the features described yet still benefit from at least some of the advantages of such features. Those of ordinary skill in the art may readily devise their own implementations of the system and/or method that incorporate one or more of the features of the present invention and fall within the spirit and scope of the present disclosure as defined by the appended claims.

1. A method for providing financial data to a user, the method comprising the steps of:
defining a trigger event;
retrieving financial data from a database based on the user;
determining an occurrence of the trigger event based on a portion of the financial data;
displaying the financial data to the user; and
identifying the portion of the financial data to the user based on the determining step.

2. The method of claim 1, wherein the financial data includes loan rates.

3. The method of claim 1, wherein the financial data includes deposit rates.

4. The method of claim 1, wherein the defining step includes determining a date.

5. The method of claim 4, wherein determining a date includes determining a date of maturity of at least one of a deposit and a loan.

6. The method of claim 1, wherein the defining step includes determining an interest rate.

7. The method of claim 6, wherein the determining step includes determining if the portion of the financial data is greater than the interest rate.

8. The method of claim 6, wherein the determining step includes determining if the portion of the financial data is less than the interest rate.

9. The method of claim 6, wherein the determining step includes determining if the portion of the financial data varies from a predetermined rate by an amount greater than the interest rate.

10. The method of claim 1, wherein the retrieving step includes retrieving financial data associated with a financial institution.

11. The method of claim 10, wherein the retrieving step include retrieving financial data associated with a competitor of the financial institution.

12. The method of claim 1, wherein the retrieving step includes retrieving interest rates offered by a financial institution associated with the user and retrieving interest rates offered by a competitor of the financial institution.

13. The method of claim 1, wherein the determining step includes determining a date of payment by a company to an employee of the company.

14. The method of claim 1, wherein the determining step includes determining if an interest rate of the portion of the financial data is greater than a predetermined interest rate.

15. The method of claim 1, wherein the determining step includes determining if a maturity date of the portion of the financial data is within a predetermined time period.

16. The method of claim 1, wherein the displaying step includes displaying interest rates offered by a financial institution associated with the user and displaying interest rates offered by a competitor of the financial institution.

17. The method of claim 1, wherein the identifying step includes highlighting the portion of the financial data.

18. The method of claim 17, wherein highlighting the portion of the financial data includes highlighting the portion with a color based on the determining step.

19. The method of claim 17, wherein highlighting the portion of the financial data includes highlighting the portion of the financial data based on a change of the financial data.

20. The method of claim 1, further comprising comparing the portion of the financial data to historical financial data and identifying the portion of the financial data to the user based on the comparing step.

21. The method of claim 1, further comprising determining a recommendation based on the financial data and presenting the recommendation to the user.

22. The method of claim 21, wherein determining a recommendation includes determining a recommended interest rate based on the financial data.

23. The method of claim 22, wherein the financial data includes financial data of a financial institution associated with the user and a competitor of the financial institution.

24. A system for providing financial data to a user across an network, the system comprising:
a database having stored therein financial data associated with the user and a number of trigger events; and
a server electrically coupled to the database and the network, the server configured to (i) retrieve financial data from the database based on a request from the user, (ii) determine an occurrence of the trigger event based on a portion of the financial data, (iii) transmit the financial data to the user, and (iv) identify the portion of the financial data to the user based on the occurrence of the trigger event.

25. The system of claim 24, wherein the financial data includes loan rates.

26. The system of claim 24, wherein the financial data includes deposit rates.

27. The system of claim 24, wherein the trigger event includes a date of maturity of at least one of a deposit and a loan.

28. The system of claim 24, wherein the trigger event includes an interest rate.

29. The system of claim 28, wherein the server configured to determine an occurrence of the trigger event includes a server configured to determine if the portion of the financial data is greater than the interest rate.

30. The system of claim 28, wherein the server configured to determine an occurrence of the trigger event includes a server configured to determine if the portion of the financial data is less than the interest rate.

31. The system of claim 28, wherein the server configured to determine an occurrence of the trigger event includes a server configured to determine if the portion of the financial data varies from a predetermined rate by an amount greater than the interest rate.

32. The system of claim 24, wherein the server configured to retrieve financial data from the database includes a server configured to retrieve financial data associated with a financial institution.

33. The system of claim 32, wherein the server configured to retrieve financial data from the database includes a server configured to retrieve financial data associated with a competitor of the financial institution.

34. The system of claim 24, wherein the server configured to retrieve financial data from the database includes a server configured to retrieve interest rates offered by a financial institution associated with the user and retrieve interest rates offered by a competitor of the financial institution.

35. The system of claim 24, wherein the server configured to determine an occurrence of the trigger event includes a server configured to determine a date of payment by a company to an employee of the company.

36. The system of claim 24, wherein the server configured to determine an occurrence of the trigger event includes a server configured to determine if an interest rate of the portion of the financial data is greater than a predetermined interest rate.

37. The system of claim 24, wherein the server configured to determine an occurrence of the trigger event includes a server configured to determine if a maturity date of the portion of the financial data is within a predetermined time period.

38. The system of claim 24, wherein the server configured to identify the portion of the financial data to the user includes a server configured to highlight the portion of the financial data.

39. The system of claim 38, wherein to highlight the portion of the financial data includes to highlight the portion with a color based on the determining step.

40. The system of claim 38 wherein to highlight the portion of the financial data includes to highlight the portion of the financial data based on a change of the financial data.

41. An article comprising a computer-readable signal-bearing medium having therein a plurality of instructions which, when executed by a processor, cause the processor to:
retrieving financial data from a database based on a user;
determine an occurrence of a trigger event based on a portion of the financial data;
display the financial data to the user; and
identify the portion of the financial data to the user based on the determining step.

42. A method of determining a financial rate for a financial institution, the method including:
determining historical financial data related to the financial institution;
determining current financial data related to the financial institution;
constructing a financial rate matrix based on the historical financial data and the current financial data, the financial rate matrix having a number of financial rates stored therein;
selecting one of the number of financial rates; and
determining a market revenue value based on the one of the number of financial rates.

43. The method of claim 42, wherein the financial rate is one of a deposit interest rate and a loan interest rate.

44. The method of claim 42, further comprising adjusting the one of the number of financial rates based on a funding rate.
